(19) United States
(12) Patent Application Publication
(10) Pub. No.: US 2015/0027506 A1
(43) Pub. Date: Jan. 29, 2015

(54) TENT WITH PROJECTOR HOLDER, FREE STANDING PROJECTOR HOLDER, AND SYSTEM FOR PROJECTING IMAGES WITHIN A TENT

(71) Applicant: Simcha Brown, Cedarhurst, NY (US)

(72) Inventor: Simcha Brown, Cedarhurst, NY (US)

(21) Appl. No.: 14/297,615

(22) Filed: Jun. 5, 2014

Related U.S. Application Data
(60) Provisional application No. 61/832,044, filed on Jun. 6, 2013.

(51) Int. Cl. E04H 15/02; G03B 21/14; E04H 15/34

(52) U.S. Cl. CPC E04H 15/02; E04H 15/34; G03B 21/145
USPC 135/96

(57) ABSTRACT

A tent comprising a projector-holder, a free standing projector-holder for use in a tent, and a system for projecting images upon an interior of a tent are described and disclosed. In some embodiments, the tent may comprise: a tent-covering, at least one tent-frame-member, and a projector-holder. The at least one tent-frame-member may be configured to provide a three-dimensional-shape of the tent when the at least one tent-frame-member may removably attach to the tent-covering. The projector-holder may comprise a tent-communication-means, a movement-damper, and a projector-mount; wherein these three components may all be connected in serial fashion. In exemplary embodiments, the tent-communication-means may be a clamp, the movement-damper may be a flexible-gooseneck-arm configured to reduce undesirable movements, and the projector-mount may be a bolt-turning-means configured to removably attach the projector-mount to a projector. The clamp in some embodiments may be configured to removably attach to the least one tent-frame-member.

### PRIORITY NOTICE

The present application claims priority under 35 U.S.C. §119(e) to U.S. Provisional Patent Application Ser. No. 61/832,044 filed on Jun. 6, 2013, the disclosure of which is incorporated herein by reference in its entirety.

### STATEMENT REGARDING FEDERAL SPONSORSHIP

No part of this invention was a result of any federally sponsored research.

### TECHNICAL FIELD OF THE INVENTION

The present invention relates to tents comprising projector-holders within the tent to project images upon an interior of the tent. The present invention relates to free standing projector-holders that may be located within a tent to project images upon an interior of the tent. The present invention relates to a system for projecting images from a projector upon an interior of a tent.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

Tents, including canopies and sunshades may be used in a variety of ways and by a variety of users. Tents may be used outdoors or indoors. Traditionally, the outdoor use may be for a shelter, when camping, to provide warmth and protection from the elements, whether elements may be sun, cold, rain, snow, and/or wind. Tents are also often used indoors, by both children and adults. Children often enjoy playing within tents, whether the tent is indoors or outdoors. Adults may use tents indoors at tradeshows and expos to exhibit and market various goods and services. In all these scenarios, (i.e. used by children and/or adults, and whether used indoors and/or outdoors) it would desirable to be able to project images from a projector onto an interior of the tent, whether projecting onto interior walls and/or the interior of a roof of the tent.

However, the prior art does not provide a means for mounting a projector within a tent. Instead, the current means of using a projector within a tent are merely cobbled together techniques where the means for holding the projector was not designed at the outset for use within a tent. For example, one may place a portable projector table, with a projector sitting upon the top of the table into a tent. However, such a solution creates may create other problems. For example, many tents are simply too small to readily accommodate both the portable projector table and occupants. The portable projector may easily get in the way and become cumbersome. Additionally, a portable projector table may place the projector at a height which may interfere with viewing from occupants within the tent, particularly if the occupants want to sit or lay down.

Thus, it would be desirable to removably mount the projector from above (e.g. from the roof) within the tent to minimize viewing problems. Such a removable mounting may also benefit from being stable, i.e. relatively free from undesirable movement and vibration. And such a removable mounting may also benefit from being a safe mounting, i.e. secured, such that a likelihood of the projector falling is minimized.

Additionally, the current tents themselves may be make poor viewing surfaces because of excessive light penetration through the fabric material of most current tents. Thus it would be desirable if at least some interior portion of the tent would be specifically designed with image projections in mind, i.e. to reduce light penetration through the material of the tent. Additionally, it may help if the interior surface was relatively smooth.

There is a need in the art for a tent which may comprise a projector-holder. There is a need in the art for a tent which may comprise a means for reducing light penetration through the material of the tent. There is a need in the art for a free standing projector-holder which may be used in existing tents, wherein such tents may not comprise a projector-holder. There is a need in the art for a dedicated system for viewing projected images within a tent.

It is to these ends that the present invention has been developed.

### BRIEF SUMMARY OF THE INVENTION

To minimize the limitations in the prior art, and to minimize other limitations that will be apparent upon reading and understanding the present specification, the present invention describes a tent comprising a projector-holder, a free standing projector-holder for use in a tent, and a system for projecting images upon an interior of a tent.

In some embodiments, the tent may comprise: a tent-covering, at least one tent-frame-member, and a projector-holder. The tent-covering may comprise the roof and walls of the tent; and in some embodiments, the tent-covering may also comprise a floor. The tent-covering may comprise both interior surfaces and exterior surfaces disposed opposite of the interior surfaces. The at least one tent-frame-member may be configured to provide a three-dimensional-shape of the tent when the at least one tent-frame-member may removably attach to the tent-covering. The projector-holder may comprise a tent-communication-means, a movement-damper, and a projector-mount; wherein these three components may all be connected in serial fashion. In exemplary embodiments, the tent-communication-means may be a clamp, the movement-damper may be a flexible-gooseneck-arm configured to reduce undesirable movements, and the projector-mount may be a bolt-turning-means configured to removably attach the projector-mount to a projector. The clamp in some embodiments may be configured to removably attach to the least one tent-frame-member.

In some embodiments which may comprise the floor, the floor may comprise a seat, wherein the seat may be removable.

In some embodiments, the tent-covering may comprise a material that may reduce light penetration into the interior of the tent. The material may be a blackout fabric.

It is an objective of the present invention to provide a tent with a capability to stably and safely removably mount a projector within a tent, such that projected images upon an interior of the tent may be viewed. Such a capability may be provided by various embodiments of projector-holders.

It is another objective of the present invention to provide projector-holders which may be capable of stably and safely removably mounting a variety of different projector makes and models.

It is another objective of the present invention to provide projector-holders which may be free standing, such that the projector-holder may be used in a variety of different sized and styles of tents, wherein such tents do not have a projector holding means.

It is another objective of the present invention to provide a tent, wherein the tent may comprise a tent-covering and wherein the tent-covering may comprise a material that may reduce light penetration into the interior of the tent. The material may be a blackout fabric. In some embodiments, the entirety of the tent-covering may be substantially constructed of such a material. In other embodiments, only a portion of the tent-covering may be constructed of such a material, wherein the portion is less than the entire tent-covering.

It is another objective of the present invention to provide a tent, wherein the tent may comprise a seat. In some embodiments, the tent-covering may comprise a floor and the floor may comprise the seat. In some embodiments, the seat may be removably attached to the floor, e.g. by Velcro®. In some embodiments, the seat may be inflatable.

It is another objective of the present invention to provide a tent-covering, wherein the tent-covering may comprise a heat-vent, wherein the heat-vent may permit heat from inside the tent to escape. Such heat may be generated from users of the tent (i.e. occupants) and/or from an operating projector.

It is yet another objective of the present invention to provide a system for projecting images upon an interior of a tent with a projector located within the tent and wherein the projector may be removably held by a projector-holder.

These and other advantages and features of the present invention are described herein with specificity so as to make the present invention understandable to one of ordinary skill in the art, both with respect to how to practice the present invention and how to make the present invention.

### BRIEF DESCRIPTION OF THE SEVERAL VIEWS OF THE DRAWINGS

Elements in the figures have not necessarily been drawn to scale in order to enhance their clarity and improve understanding of these various elements and embodiments of the invention. Furthermore, elements that are known to be common and well understood to those in the industry are not depicted in order to provide a clear view of the various embodiments of the invention.

FIG. 1(a) depicts an exemplary embodiment of a tent with a projector-holder, removably holding a projector, all shown from a perspective view.

FIG. 1(b) depicts the exemplary embodiment of FIG. 1(a), but shown from a frontal view.

FIG. 1(c) depicts the exemplary embodiment of FIG. 1(a), but shown from a perspective view that also depicts a seat.

FIG. 1(d) depicts an exemplary embodiment of a close up view of the projector-holder of FIG. 1(a).

FIG. 2(a) depicts an exemplary embodiment of a projector-holder comprising a flexible-gooseneck-arm and a bolt-turning-means, shown from a perspective view.

FIG. 2(b) depicts an exemplary embodiment of a bolt-turning-means, which may be an exemplary embodiment of a projector-mount, shown from a side view.

FIG. 2(c) depicts an exemplary embodiment of a projector-holder comprising a flexible-gooseneck-arm and a three-arm-mount, shown from a perspective view.

FIG. 2(d) depicts an exemplary embodiment of a projector-holder, shown from a top view looking down upon the projector-holder.

FIG. 3 depicts an exemplary embodiment of a free standing projector-holder, shown from a top view looking down upon the projector-holder.

FIG. 4 depicts an exemplary embodiment of a tent with a projector-holder, wherein the tent may comprise a removable seat, shown from a perspective view with the seat removed from inside the tent.

### DETAILED DESCRIPTION OF THE INVENTION

A tent comprising a projector-holder, a free standing projector-holder for use in a tent, and a system for projecting images upon an interior of a tent are described and disclosed. In such embodiments, the projector may be removably located within the tent. In such embodiments, the projector may project images upon a portion of the interior of the tent. Images may be projected onto interior walls and/or the interior of a roof of the tent. In some embodiments this portion may be less than a surface area of one interior wall, less than a surface area of the interior of the roof, and/or substantially all interior surfaces of the tent. In some embodiments, the portion may be substantially constructed of a material that reduces light penetration into the interior of the tent.

In some embodiments, the tent may comprise: a tent-covering, at least one tent-frame-member, and a projector-holder. The tent-covering may comprise the roof and walls of tent; and in some embodiments, the tent-covering may also comprise a floor. The tent-covering may comprise both interior surfaces and exterior surfaces disposed opposite of the interior surfaces. The at least one tent-frame-member may be configured to provide a three-dimensional-shape of the tent when the at least one tent-frame-member may removably attach to the tent-covering. The projector-holder may comprise a tent-communication-means, a movement-damper, and a projector-mount; wherein these three components may all be connected in serial fashion. In exemplary embodiments, the tent-communication-means may be a clamp, the movement-damper may be a flexible-gooseneck-arm configured to reduce undesirable movements, and the projector-mount may be a bolt-turning-means configured to removably attach the projector-mount to a projector. The clamp in some embodiments may be configured to removably attach to the least one tent-frame-member.

In the following discussion that addresses a number of embodiments and applications of the present invention, reference is made to the accompanying drawings that form a part thereof, where depictions are made, by way of illustration, of specific embodiments in which the invention may be practiced. It is to be understood that other embodiments may be utilized and changes may be made without departing from the scope of the invention.

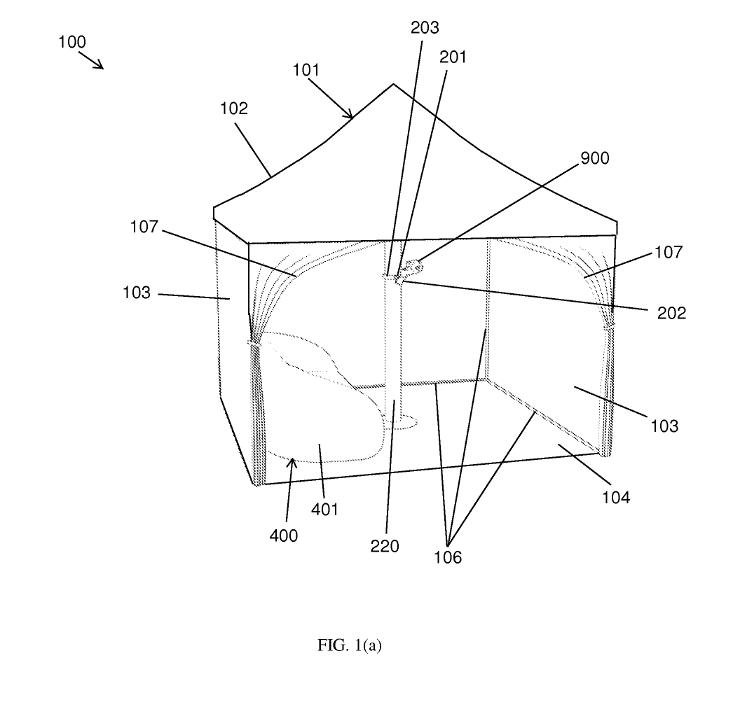

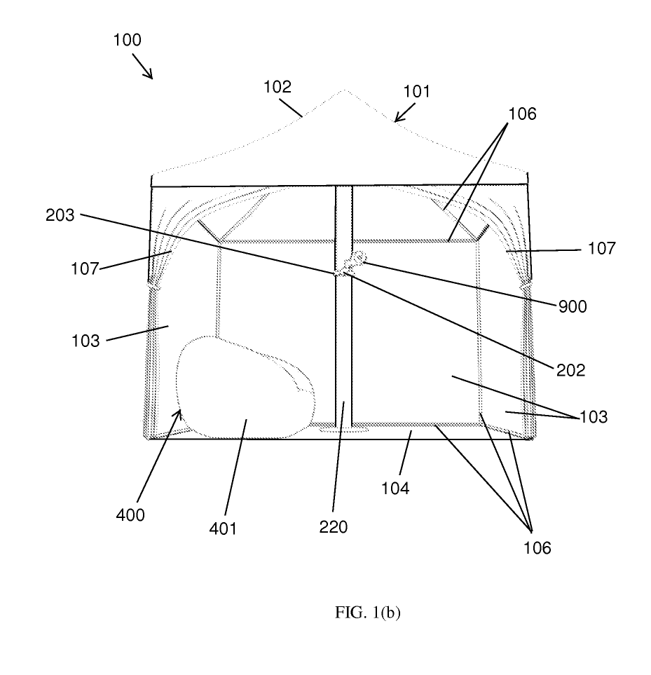

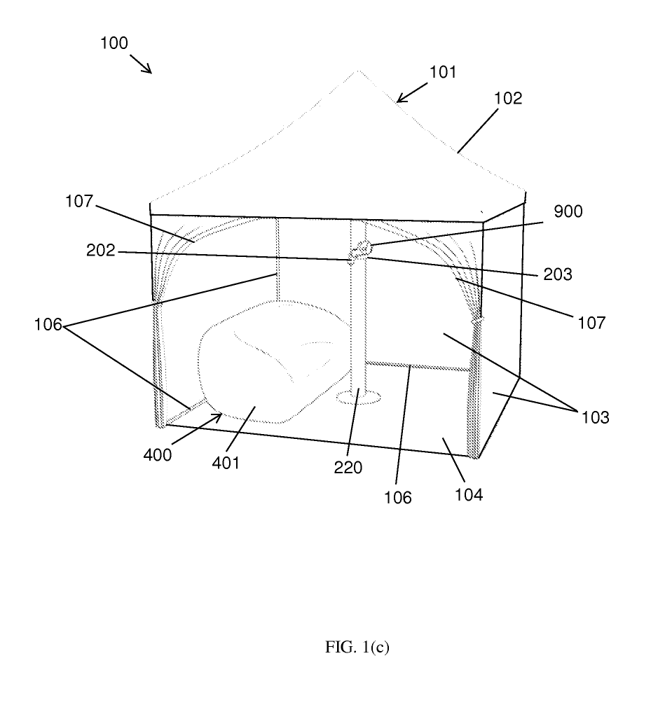

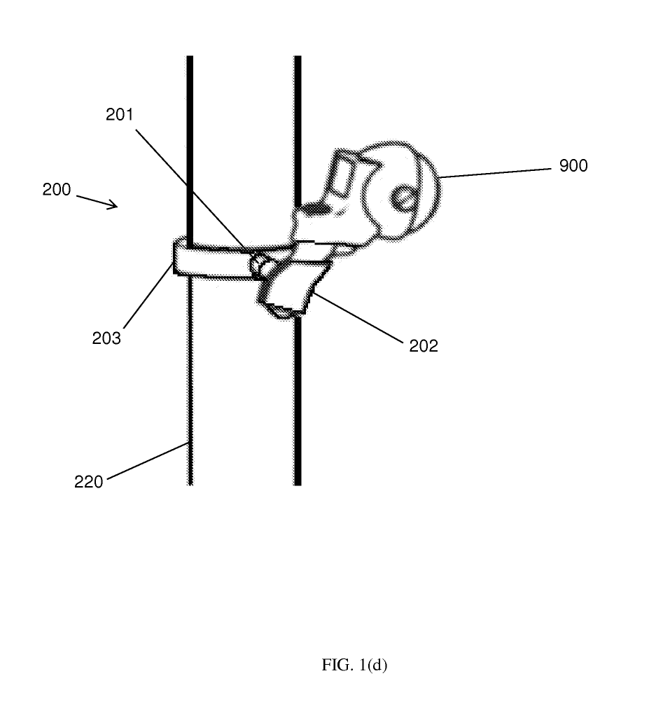

FIG. 1(a) depicts an exemplary embodiment of a tent 100 with a projector-holder 200, removably holding a projector 900, all shown from a perspective view. FIG. 1(b) depicts the exemplary embodiment of FIG. 1(a), but shown from a frontal view. FIG. 1(c) depicts the exemplary embodiment of FIG. 1(a), but shown from a perspective view that also depicts a seat 400. FIG. 1(d) depicts an exemplary embodiment of a close up view of projector-holder 200 as depicted in FIG. 1(a).

As shown in the FIG. 1 series of figures, in some embodiments, tent 100 may comprise: a tent-covering 101, at least one tent-frame-member 106, and a projector-holder 200. In some embodiments, tent-covering 101 may comprise a roof 102 and walls 103 of tent 100.

In some embodiments, at least one tent-frame-member 106 may be configured to provide a three-dimensional-shape of tent 100 when at least one tent-frame-member 106 may be removably attached to tent-covering 101. That is, at least one tent-frame-member 106 may provide structural support to tent-covering 101 that may provide the three-dimensional-shape of tent 100. In some embodiments, at least one tent-frame-member 106 may be semi-rigid. In some embodiments, at least one tent-frame-member 106 may be substantially rigid (e.g. tubular aluminum and/or steel).

In some embodiments, at least one tent-frame-member 106 may comprise a plurality of tent-frame-members 106. Each tent-frame-member 106 selected from the plurality of tent-frame-members 106 may function to provide the structural support to tent-covering 101 that may provide the three-dimensional-shape of tent 100. The larger the tent 100 in a given embodiment, and/or the more complex a geometry of the three-dimensional-shape of tent 100 in a given embodiment, then at least one tent-frame-member 106 may comprise the plurality of tent-frame-members 106. Tents 100 may take on a variety of three-dimensional shapes, including the pointed roof embodiment show in the FIG. 1 series of figures. However, other tents 100 may be shaped with more than one pointed roof or with domed roofs, wherein the walls may merge into the roof.

In some embodiments, at least one tent-frame-member 106 may be elongate. In some embodiments, at least one tent-frame-member 106 may be of a tubular construction. Such a tubular construction may have a circular, an ovoid, a square, or a rectangular cross-section. Such a tubular construction may have an elastic material running down a center, wherein the elastic material may link one tent-frame-member 106 to another tent-frame-member. In some embodiments, one end of tent-frame-member 106 may be tapered and the remaining end may not be tapered, such that one tent-frame-member 106 may be modularly attached to another tent-frame-member 106.

In some embodiments, tent-covering 101 may further comprise a means-to-attach-to-tent-frame-member. In some embodiments, the means-to-attach-to-tent-frame-member may comprise loops, clips, and the like; such that the means-to-attach-to-tent-frame-member may removably attach to tent-frame-members 106.

In some embodiments, tent-frame-members 106 may be located on an interior of tent 100. In some embodiments, tent-frame-members 106 may be located on an exterior of tent 100.

In some embodiments, at least one tent-frame-member further 106 may comprise a means-to-attach-to-tent-covering. The means-to-attach-to-tent-covering and the means-to-attach-to-tent-frame-member may be complimentary with respect to each other, permitting removable attachment to each other.

In some embodiments, tent 100 may comprise a canopy or a sun-shade.

In some embodiments, tent-covering 101 may comprise a floor 104. In some embodiments, floor 104 may be integral with walls 103, such that floor 104 and walls 103 may be one single article of manufacture. In some embodiments, floor 104 may be removable from walls 103. In some embodiments, tent 100 may not comprise floor 104.

In some embodiments, roof 102 and walls 103 may be integral with respect to each other, such that roof 102 and walls 103 may be one single article of manufacture. In some embodiments, roof 102 and walls 103 may be separate articles of manufacture that may removably attach to each other by a roof-wall-attachment-means. The roof-wall-attachment-means may be selected from the group comprising Velcro® (e.g. a plurality of hooks and a plurality of complimentary hooks), snap connectors, zippers, buttons, and the like.

In some embodiments, tent-covering 101 may comprise at least one sealable opening. The at least one sealable opening may be sealable by Velcro® (e.g. a plurality of hooks and a plurality of complimentary hooks), snap connectors, zippers, buttons, drawstrings, ties, and the like. In some embodiments, the at least one sealable opening may be a door 107. Door 107 may provide user access to the interior of the tent. For example, door 107 may be depicted in the FIG. 1 series of figures. In some embodiments, the at least one sealable opening may be at least one window. The at least one window may provide ventilation to the interior of tent 100. In some embodiments, the at least one sealable opening may be at least one heat-vent. The at least one heat-vent, when open, may provide a means for heat to escape the interior of tent 100.

In some embodiments, tent-covering 101 may comprise a portion of wall 103 that may be substantially constructed of a material that reduces light penetration into the interior of tent 100. The portion in some embodiments may comprise substantially all of the interior surfaces of tent 100. The portion in some embodiments may comprise some or substantially all of roof 102. For example, and without limiting the scope of the present invention, the portion may be an entire wall 103 (interior and/or exterior).

Such a material may be a blackout fabric. Blackout fabrics may not be a black color, i.e. blackout fabrics may be colors other than black or it may be black or it may be white. Blackout fabrics may reduce visible light penetration through the blackout fabric. Thus incorporation of a blackout fabric into the portion of tent-covering 101 may improve the viewing quality of projected images onto tent-covering 101. Some blackout fabric may comprise a heavyweight fabric, wherein the blackout fabric comprises a plastic liner. The plastic liner may be adhered to textile weaves of the blackout fabric. In other blackout fabrics there may be no plastic liner. For example, and without limiting the scope of the present invention, some blackout fabrics may comprise a heavyweight polyester cotton blend, such as about 70% polyester and about 30% cotton. Blackout fabrics may also comprise a sound dampening property. In some embodiments, all of tent-covering 101 may be substantially constructed of such blackout fabrics.

In some embodiments, the interior surface of tent 100 that may correspond to the portion, may also be smooth to improve image quality of projected images onto the portion.

In some embodiments, projector-holder 200 may comprise a tent-communication-means 203, a movement-damper 201, and a projector-mount 202. For example, see FIG. 1(d). In FIG. 1(d), tent-communication-means 203 may be a clamp or a clip. In FIG. 1(d), movement-damper 201 may be a flexible-gooseneck-arm. In FIG. 1(d), projector-mount 202 may be a support-collar, wherein the support-collar is substantially a hollow cylinder configured to accept and support a portion of projector 900.

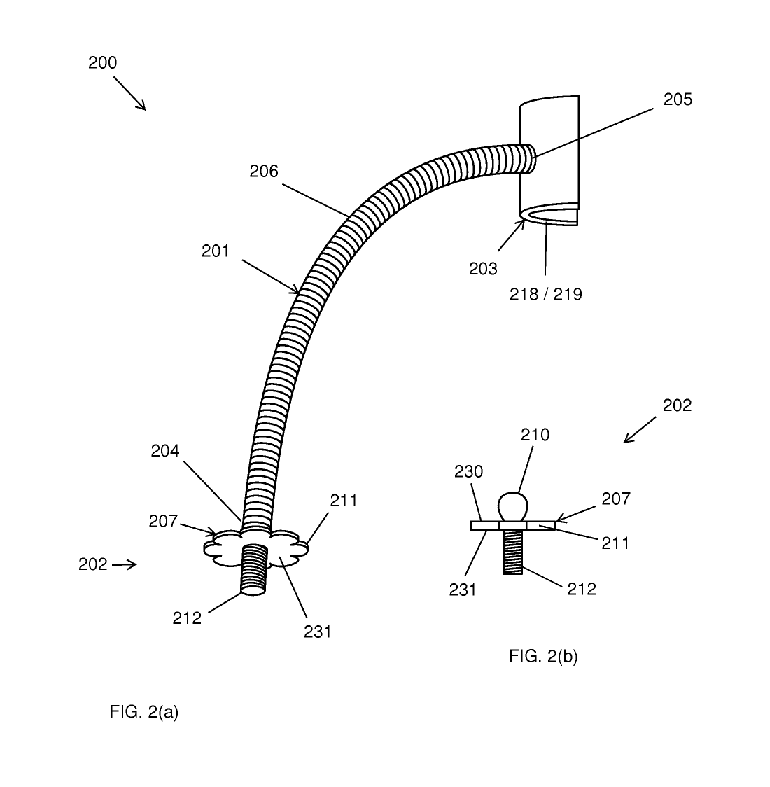

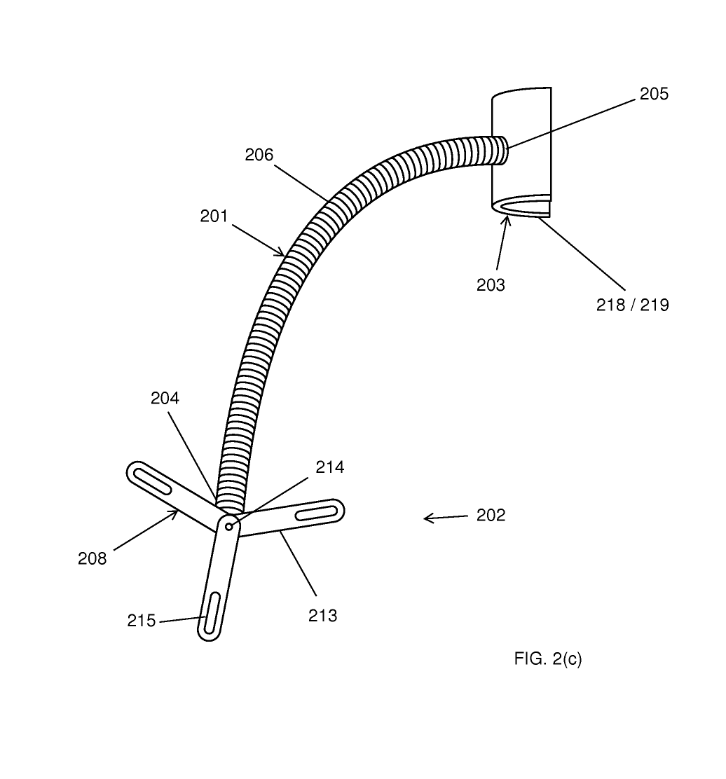

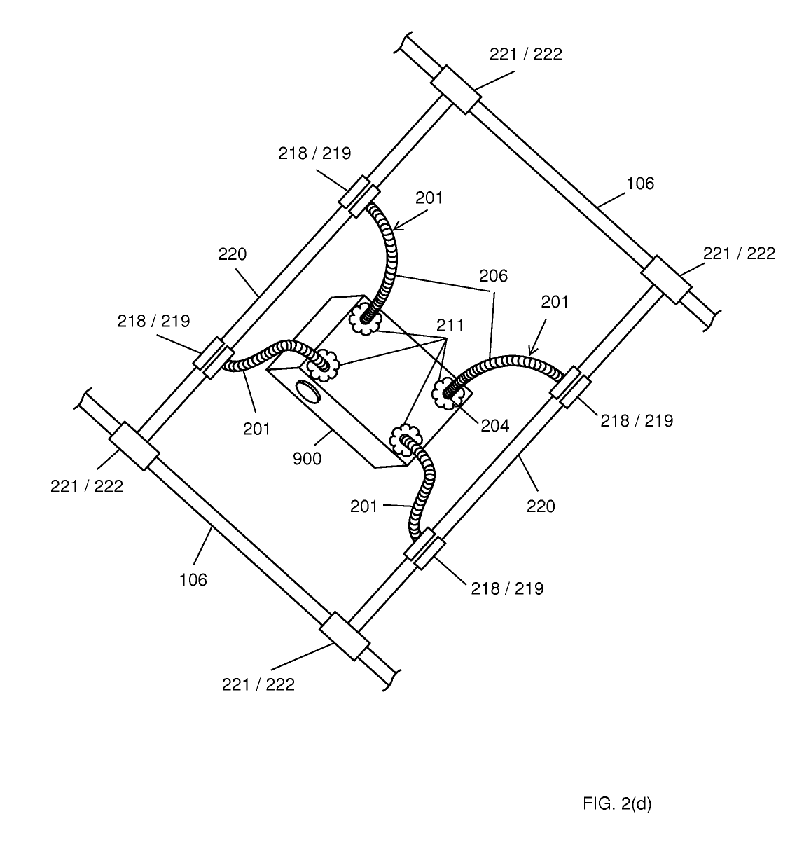

See also FIG. 2(a) for another projector-holder 200 embodiment. Movement-damper 201 may be an elongate-member. Movement-damper 201 may comprise a first-terminal-end 204 and a second-terminal-end 205. Second-terminal-end 205 may be disposed opposite of first-terminal-end 204.

First-terminal-end 204 may be connected to projector-mount 202. In some embodiments, first-terminal-end 204 may be permanently connected to projector-mount 202. In some embodiments, first-terminal-end 204 may be removably connected to projector-mount 202.

Second-terminal-end 205 may be connected to tent-communication-means 203. In some embodiments, second-terminal-end 205 may be permanently connected to tent-communication-means 203. In some embodiments, second-terminal-end 205 may be removably connected to tent-communication-means 203.

Movement-damper 201 may comprise a spring or a flexible-goose-neck-arm 206. Movement-damper 201 may be configured to reduce undesirable movement. Movement-damper 201 may function to not only provide a physical link from projector-mount 202 to tent-communication-means 203, but also to dampen undesirable vibrations and movement from interfering with the projections emanating from projector 900.

In some embodiments, projector-holder 202 may comprise one, two, three, or four movement-dampers 201. For example, and without limiting the scope of the present invention, when movement-damper 201 comprises flexible-goose-neck-arm 206, a number of flexible-goose-neck-arms 206 used to support projector 900, may depend upon a weight of a given model of projector 900 and upon load characteristics that each individual flexible-goose-neck-arm 206 may hold. Some portable projectors 900 may have weights from two pounds or less, while other projector 900 may weigh more (e.g. five pounds). In some embodiments, some individual flexible-goose-neck-arms 206 may support up to two pounds. For example, FIG. 2(d) may depict projector-holder 200 comprising four flexible-goose-neck-arms 206.

Projector-mount 202 may be configured to removably attach to the projector 900. In some embodiments, projector-mount 202 may comprise a bolt-turning-means 207 (FIG. 2(a) and FIG. 2(b)), a three-arm-mount 208 (FIG. 2(c)), a shelf or the support-collar (FIG. 1 series, labeled as 202).

In some embodiments, bolt-turning-means 207 may comprise a ball 210, a flange 211, and a bolt 212. See FIG. 2(a) and FIG. 2(b). Flange 211 may be substantially flat and flange 211 may comprise a first-flat-surface 230 and a second-flat-surface 231. Second-flat-surface 231 may be disposed opposite of first-flat-surface 230. First-flat-surface 230 may be connected to ball 210. Second-flat-surface 231 may be connected to bolt 212. That is, bolt 212 may extend (protrude) from second-flat-surface 231, such that a longitude of bolt 212 may be substantially perpendicular to a planar surface of second-flat-surface 231. Flange 211 may be configured to be gripped by the user to turn bolt 212. Ball 210 may be configured to be held by first-terminal-end 204 to form a ball-and-socket-connection, such that bolt-turning-means 207 may rotate about a central axis of bolt-turning-means 207 with respect to first-terminal-end 204 of movement-damper 201 (such as flexible-gooseneck-arm 206). Bolt 212 may be sized to be received into a threaded-receiving hole on the projector 900.

Three-arm-mount 208 may comprise three arms 213 and a pivot 214. See FIG. 2(c). Each arm 213 may be elongate. All three arms 213 may all be connected at one end of each arm 213 by pivot 213, such that each arm 213 may pivots with respect to the other arms 213. First-terminal-end 204 may be connected to three-arm-mount 208 at pivot 214. The other free end of each arm 213 may comprises a slot 215. Slot 215 may comprise a longitude, wherein the longitude of slot 215 may be substantially parallel with a longitude of arm 213. A length of slot 215 may be less than a length of arm 213. Slot 215 may be sized to receive a separate-bolt for attaching (e.g. removably attaching) each arm 213 to the threaded-receiving-holes on projector 900. The ability of each arm 213 to pivot about pivot 214 and the inclusion of slot 215 may permit three-arm-mount 208 to be removably attached to a wide diversity of projector 900 model types, using up to three separate-bolts to secure three-arm-mount 208 to projector 900.

In embodiments of projector-mount 202, wherein projector-mount 202 may comprise the shelf, first-terminal-end 204 may be connected to the shelf (not depicted). The shelf may be configured to support projector 900. The shelf may comprise a strap or a sleeve. The strap may be sized to wrap around projector 900 when projector 900 may be supported by the shelf. The strap may comprise two sub-straps, wherein each sub-strap may extend from a transverse-width terminal end of the shelf, such that the two sub-straps may wrap around projector 900 and wherein the two sub-straps may removably attach to each other to form the strap. The sleeve may be sized to wrap around projector 900 when projector 900 may be supported by the shelf. The sleeve may frictionally hold projector 900 to the shelf. The sleeve may be substantially constructed of an elastomeric material. For example, and without limiting the scope of the present invention, the sleeve may be substantially constructed of an elastic fabric.

Tent-communication-means 203 may be configured to put projector-holder 200 and the interior of tent 100 in physical contact with each other. Projections from projector 900 may project onto the interior of tent 100 (e.g. onto tent-covering 101), such that the projections may be viewable by the user from the interior of tent 100.

In some embodiments, tent-communication-means 203 may comprise a clamp 218 or a clip 218. For example, see FIG. 2(a), FIG. 2(c), and FIG. 2(d). In some embodiments, second-terminal-end 205 may connect to either clamp 218 or clip 219. In embodiments utilizing clamp 218, clamp 218 may removably attach to tent-frame-member 106. Clamp 218 may be spring loaded to provide the frictional gripping functionality. In embodiments utilizing clip 219, clip 219 may removably attach to tent-frame-member 106.

In various embodiments, tent-frame-members 106 may be vertical, horizontal or both, with respect to a ground that tent 100 may be erected on. For example, if a mounting-rail 220, as depicted in the FIG. 1 series of figures, were instead a tent-frame-member 106, then such a tent-frame-member 106 would be a vertical tent-frame-member 106 that tent-communication-means 203 may be removably attached to. In the FIG. 1 series of figures, if mounting-rail 220 was supporting roof 102, then mounting-rail 220 would be a tent-frame-member 106. A difference between mounting-rail 220 and tent-frame-member 106 may be that mounting-rails 220 do not support tent-covering 101, whereas tent-frame-members 106 do.

In some embodiments, tent-communication-means 203 may comprise at least one mounting-rail 220. At least one mounting-rail 220 may be telescopic, accommodating different lengths. See e.g. FIG. 2(d). At least one mounting-rail 220 may be vertical or horizontal, with respect to a ground that tent 100 may be erected on. See e.g. the FIG. 1 series, where mounting-rail 220 may be vertical. In such embodiments including at least one mounting-rail 220, tent-communication-means 203 may further comprise clamp 218 or clip 219. Either clamp 218 or clip 219 may removably attach to at least one mounting-rail 220.

See e.g. FIG. 2(d), where there may be a pair of substantially parallel and substantially horizontal mounting-rails 220. Either clamps 218 or clips 219 (of tent-communications-means 203) may be removably attached to this pair of substantially parallel and substantially horizontal mounting-rails 220. (Recall, second-terminal-end 205 may connect to either clamp 218 or clip 219, depending upon the embodiment, see e.g. FIG. 2(a) and FIG. 2(c).)

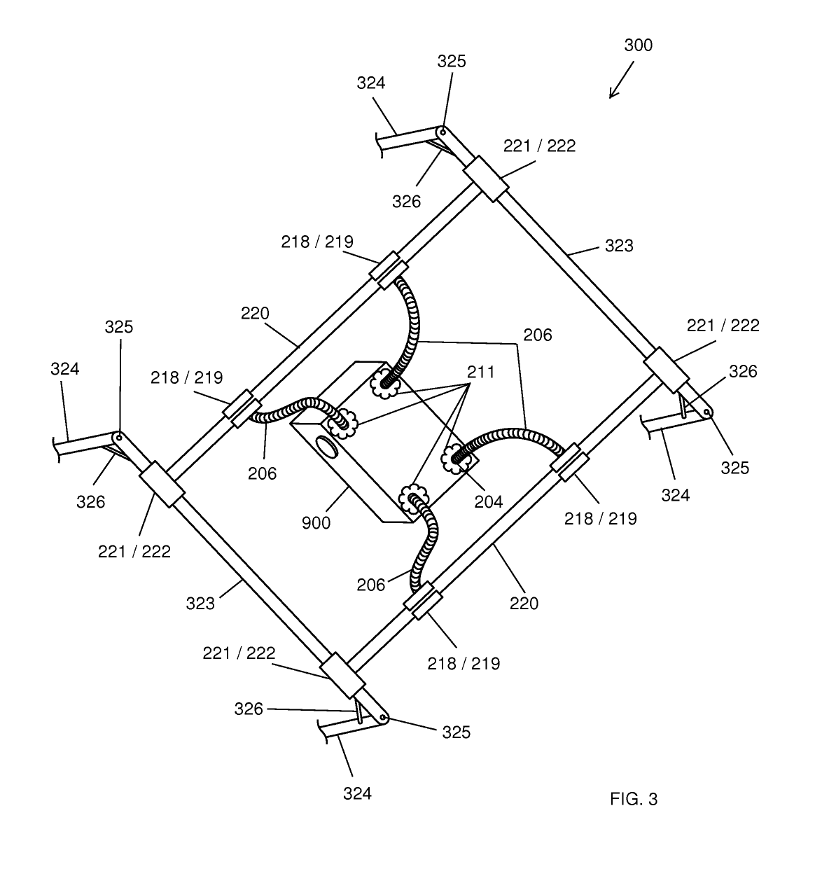

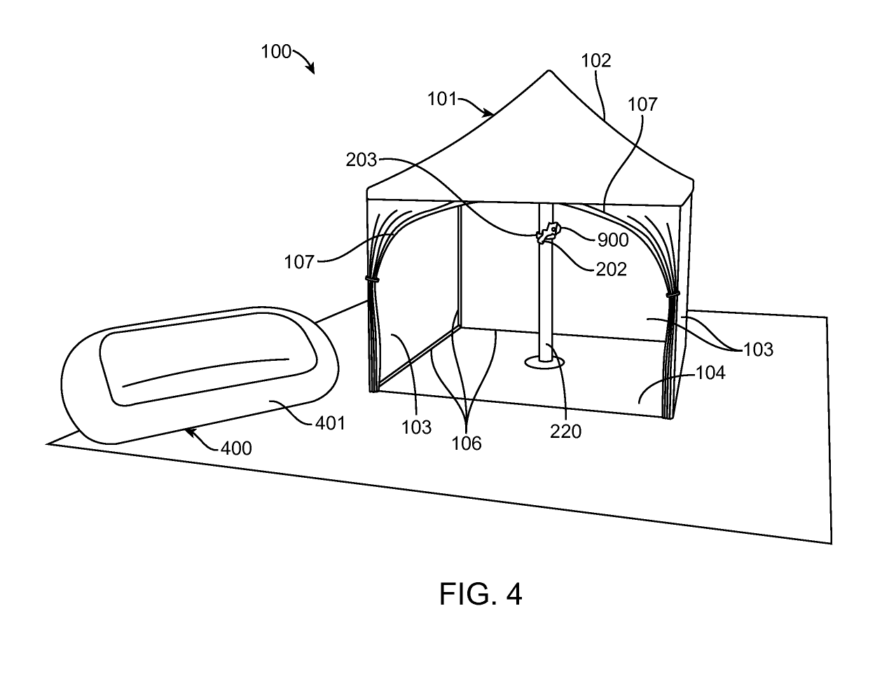

In some embodiments, at least one mounting-rail 220 may be elongate and may terminate at two ends, in either a member-clamp 221 or a member-clip 222. See e.g. FIG. 2(d). Either member-clamp 221 or member-clip 222 may removably attach to either tent-frame-member 106 (FIG. 2(d)) or to a mounting-rail-support-member 323 (FIG. 3). In FIG. 2(d), the pair of tent-frame-members 106 may be substantially parallel and substantially horizontal, wherein each tent-frame-member 106 may be separated from the other tent-frame-member 106 by the pair of mounting-rails 220. The entire assembly depicted in FIG. 2(d) may be located towards a top of tent 100, within the interior of tent 100. That is, the entire depicted assembly may be located closer to roof 102 than to floor 104 or to the ground.

FIG. 3 may depict a free standing projector-holder 300 shown from a top view looking downwards. Free standing projector-holder 300 may be placed within the interior of tent 100. Free standing projector-holder 300 may be placed within interiors of tents without projector holders.

Projector-holder 300 may comprise: movement-damper 201, projector-mount 202, and tent-communication-means 203. Tent-communication-means 203, in projector-holder 300 embodiments, in addition to comprising clamp 218 or clip 219, may also comprise mounting-rail 220 (e.g. two substantially parallel mounting-rails 220 as depicted in FIG. 3), mounting-rail-support-member 323, legs 324, a pivot-connection 325, and a support-strut 326. Mounting-rail-support-member 323 may be elongate and may terminate into two terminal-ends. Each of the two terminal-ends of mounting-rail-support-member 323 may connect to leg 324 at pivot-connection 325. Pivot-connection 325 may connect leg 324 to mounting-rail-support-member 323. Pivot-connection 325 may permit leg 324 to pivot with respect to mounting-rail-support-member 323. Support-strut 326 may run from leg 324 to mounting-rail-support-member 323. Support-strut 326 may provide stability and structural strength to projector-holder 300 in its deployed configuration. In some embodiments, projector-holder 300 may be folded into a collapsed configuration. Leg 324 may run from pivot-connection 325 to the ground. Tent-communication-means 203 may comprise a plurality of legs 324, wherein there may be one, two, three, four, or five legs 324. For example, see FIG. 3 which may depict four legs 324 in the depicted embodiment of projector-holder 300. Exemplary embodiments may have three or four legs 324. Each leg 324 height may be configured to locate projector 900 towards the top of tent 100, i.e. closer to roof 102 than to floor 104 or to the ground. Each leg 324 may have an adjustable height, e.g. each leg 324 may be telescoping.

In some embodiments, floor 104 may comprise a seat 400. See e.g. FIG. 4. In some embodiments, seat 400 may be couch, a love seat, a chair, and the like. Seat 400 may comprise a seat-covering 401 and a structural-means. An external area of seat-covering 401 may be where the user sits and/or lays upon a portion of seat-covering 401. The structural-means may be attached to seat-covering 401. The structural-means may provide a shape and structural support to seat-covering 401.

In some embodiments, the structural-means may be an-inflatable-means. The inflatable-means may comprise at least one bladder and at least one valve. The at least one bladder may be removably fillable with air and when the at least one bladder may be filled with air, the inflatable-means may provide the shape and structural support to seat-covering 401, such that seat-covering 401 may support a weight of one or more users. The air may be delivered to or removed from the at least one bladder by the at least one valve. In exemplary embodiments, seat 400 may support the weight of six adult users.

In some embodiments, the structural-means may be a seat-frame-member. The seat-frame-member may be rigid or semi-rigid. Seat-frame-members may comprise tubular and elongate members. The seat-frame-member may be either in an unfolded configuration or in a folded configuration. When the seat-frame-member may be in the folded configuration, the seat-frame-member may provide the shape and structural support to seat-covering 401.

In some embodiments, seat 400 may be integral with floor 104, such that seat 400 and floor 104 may be permanently attached to each other. In some embodiments, seat 400 may be removable from floor 104 by a seat-attachment-means. The seat-attachment-means may be selected from the group comprising Velcro® (e.g. a plurality of hooks and a plurality of complimentary hooks), snap connectors, zippers, buttons, and the like.

In some embodiments, wall 103 may comprise seat 400, wherein the above discussion of seat 400 may apply.

Tent 100 with projector-holder 200 has been described and disclosed. Free standing projector-holder 300, for use within the interior of tent 100 or for use within the interior of other tents, has also been described and disclosed. These embodiments may be incorporated into a system for projecting images within tent 100. In some exemplary embodiments, such a system may comprise: tent 100, projector 900, and projector-holder (200 or 300). Tent 100, projector-holder 200, and projector-holder 300 may be as discussed above. Projector 900 may be removably located within the interior of tent 100. Projector 900 may comprise at least one threaded-receiving-hole sized to receive bolt 212 or the separate-bolt. Many projector models and makes comprise from one to five such threaded-receiving-holes. The system may also comprise seat 400, in embodiments where tent 100 may comprise floor 104, see e.g. FIG. 4.

A tent with a projector-holder, a free standing projector-holder for use in a tent, and a system for projecting images within a tent have been described. The foregoing description of the various exemplary embodiments of the invention has been presented for the purposes of illustration and disclosure. It is not intended to be exhaustive or to limit the invention to the precise form disclosed. Many modifications and variations are possible in light of the above teaching without departing from the spirit of the invention.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A tent with a projector-holder, wherein the tent comprises:
a tent-covering, wherein the tent-covering comprises a roof and walls of the tent; wherein the tent-covering further comprises a means-to-attach-to-tent-frame-member;
at least one tent-frame-member, wherein the at least one tent-frame-member is semi-rigid or rigid; wherein the at least one tent-frame-member is configured to provide a three-dimensional-shape of the tent when the at least one tent-frame-member is removably attached to the tent-covering; wherein the means-to-attach-to-tent-frame-member removably attaches to the at least one tent-frame-member; and
the projector-holder, wherein the projector-holder comprises a tent-communication-means, a movement-damper, and a projector-mount;
wherein the movement-damper is an elongate-member comprising a first-terminal-end and a second-terminal-end disposed opposite of the first-terminal-end, wherein the first-terminal-end is connected to the projector-mount, and the second-terminal-end is connected to the tent-communication-means; wherein the movement-damper further comprises a spring or a flexible-goose-neck-arm; wherein the movement-damper is configured to reduce undesirable movement;
wherein the projector-mount is configured to removably attach to a projector;
wherein the tent-communication-means is configured to put the projector-holder and an interior of the tent in physical contact with each other; wherein projections from the projector project onto the interior of the tent such that the projections are viewable by a user from the interior of the tent.

2. The tent according to claim 1, wherein the projector-holder comprises one, two, three, or four movement-dampers.

3. The tent according to claim 1, wherein the projector-mount comprises a bolt-turning-means, a three-arm-mount, or a shelf;
wherein the bolt-turning-means comprises a ball, a flange, and a bolt, wherein the flange is substantially flat comprising a first-flat-surface and a second-flat-surface disposed opposite of the first-flat-surface, wherein the first-flat-surface is connected to the ball and the second-flat-surface is connected to the bolt, wherein the flange is configured to be gripped by the user to turn the bolt, wherein the ball is configured to be held by the first-terminal-end to form a ball-and-socket-connection such that the bolt-turning-means rotates with respect to the movement-damper, wherein the bolt is sized to be received into a threaded-receiving hole on the projector;
wherein the three-arm-mount comprises three arms and a pivot, wherein each arm is elongate, wherein all three arms are all connected at one end of each arm by the pivot, such that each arm pivots with respect to the other arms, wherein the first-terminal-end is connected to the three-arm-mount at the pivot, wherein the other free end of each arm comprises a slot, wherein the slot is sized to receive a separate-bolt for attaching each arm to the threaded-receiving-hole on the projector; and
wherein the first-terminal-end is connected to the shelf, wherein the shelf comprises a strap or a sleeve, wherein the shelf is configured to support the projector, wherein the strap is sized to wrap around the projector when the projector is supported by the shelf, wherein the sleeve is sized to wrap around the projector when the projector is supported by the shelf and frictionally hold the projector to the shelf.

4. The tent according to claim 1, wherein the at least one tent-frame-member comprises a plurality of tent-frame-members, wherein each tent-frame-member selected from the plurality of tent-frame-members functions as the at least one tent-frame-member.

5. The tent according to claim 4, wherein the tent-communication-means comprises a clamp or a clip, wherein either the clamp or the clip removably attaches to the tent-frame-member, wherein the second-terminal-end connects to either the clamp or the clip.

6. The tent according to claim 4, wherein the tent-communication-means comprises at least one mounting-rail, and wherein the tent-communication-means comprises a clamp or a clip, wherein either the clamp or the clip removably attaches to the at least one mounting-rail, wherein the second-terminal-end connects to either the clamp or the clip; wherein the at least one mounting-rail is elongate and terminates at two ends in either a member-clamp or a member-clip, wherein either the member-clamp or the member-clip removably attaches to either the tent-frame-member or a mounting-rail-support-member, wherein the mounting-rail-support-member is a component of the projector-holder, wherein the mounting-rail-support-member is elongate and terminates into two terminal-ends, wherein each of the two terminal-ends connects to a leg at a pivot-connection, wherein the leg runs from the pivot-connection to a ground.

7. The tent according to claim 1, wherein the tent-covering comprises a portion of the wall that is substantially constructed of a material that reduces light penetration into the interior of the tent.

8. The tent according to claim 1, wherein the tent-covering further comprises a floor, wherein the floor is integral with the walls, such that the floor and the walls are one single article of manufacture.

9. The tent according to claim 8, wherein the floor further comprises a seat, wherein the seat comprises a seat-covering and a structural-means, wherein the structural-means is attached to the seat-covering and wherein the structural-means provides a shape and structural support to the seat-covering.

10. The tent according to claim 9, wherein the structural-means is an-inflatable-means, wherein the inflatable-means comprises at least one bladder and at least one valve, wherein the at least one bladder is removably fillable with air and when the at least one bladder is filled with air, the inflatable-means provides the shape and structural support to the seat-covering, wherein the air is delivered to or removed from the at least one bladder by the at least one valve.

11. The tent according to claim 9, wherein the structural-means is a seat-frame-member, wherein the seat-frame-member is rigid or semi-rigid; wherein the seat-frame-member is either in an unfolded configuration or in a folded configuration; wherein when the seat-frame-member is in the folded configuration the seat-frame-member provides the shape and structural support to the seat-covering.

12. The tent according to claim 9, wherein the seat is integral with the floor or wherein the seat is removable from the floor by a seat-attachment-means, wherein the seat-attachment-means is selected from the group consisting of a plurality of hooks and a plurality of complimentary hooks, snap connectors, zippers, and buttons.

13. The tent according to claim 1, wherein the roof and the walls are integral with respect to each other, such that the roof and the walls are one single article of manufacture.

14. The tent according to claim 1, wherein the roof and the walls are separate articles of manufacture that are removably attached to each other by a roof-wall-attachment-means, wherein the roof-wall-attachment-means is selected from the group consisting of a plurality of hooks and a plurality of complimentary hooks, snap connectors, zippers, and buttons.

15. The tent according to claim 1, wherein the tent-covering further comprises at least one sealable opening; wherein the at least one sealable opening is sealable by a plurality of hooks and a plurality of complimentary hooks, snap connectors, zippers, buttons, drawstrings, or ties.

16. The tent according to claim 15, wherein the at least one sealable opening is a door, wherein the door provides user access to the interior of the tent.

17. The tent according to claim 15, wherein the at least one sealable opening is at least one window, wherein the at least one window provides ventilation to the interior of the tent.

18. The tent according to claim 15, wherein the at least one sealable opening is at least one heat-vent, wherein the at least one heat-vent, when open, provides a means for heat to escape the interior of the tent.

19. A system for projecting images within a tent, comprising:
the tent, wherein the tent comprises:
a tent-covering, wherein the tent-covering comprises a roof and walls of the tent; wherein the tent-covering further comprises a means-to-attach-to-tent-frame-member;
at least one tent-frame-member, wherein the at least one tent-frame-member is semi-rigid or rigid; wherein the at least one tent-frame-member is configured to provide a three-dimensional-shape of the tent when the at least one tent-frame-member is removably attached to the tent-covering; wherein the at least one tent-frame-member further comprises a means-to-attach-to-tent-covering; wherein the means-to-attach-to-tent-covering and the means-to-attach-to-tent-frame-member are complimentary with respect to each other, permitting removable attachment to each other;
a projector, wherein the projector is removably located within an interior of the tent, wherein the projector comprises at least one threaded-receiving-hole sized to receive a bolt; and
a projector-holder, wherein the projector-holder comprises a movement-damper, a projector-mount, and a tent-communication-means;
wherein the movement-damper is an elongate-member comprising a first-terminal-end and a second-terminal-end disposed opposite of the first-terminal-end, wherein the first-terminal-end is connected to the projector-mount, and the second-terminal-end is connected to the tent-communication-means; wherein the movement-damper further comprises a spring or a flexible-goose-neck-arm; wherein the movement-damper is configured to reduce undesirable movement;
wherein the projector-mount is configured to removably attach to the projector; and
wherein the tent-communication-means is configured to put the projector-holder and the interior of the tent in physical contact with each other; wherein projections from the projector project onto the interior of the tent such that the projections are viewable by a user from the interior of the tent.
